(19) United States
(12) Patent Application Publication
(10) Pub. No.: US 2026/0302645 A1
(43) Pub. Date: Oct. 1, 2026

(54) SLOTTED WAVEGUIDE ANTENNA ASSEMBLY FOR PRODUCTION COST SAVING

(71) Applicant: Valeo Schalter und Sensoren GmbH, Bietigheim-Bissingen (DE)

(72) Inventors: Kevin Krupinski, Bietigheim-Bissingen (DE); Leen Sit, Bietigheim-Bissingen (DE)

(73) Assignee: Valeo Schalter und Sensoren GmbH, Bietigheim-Bissingen (DE)

(21) Appl. No.: 19/489,137

(22) PCT Filed: May 13, 2024
(86) PCT No.: PCT/EP2024/063080

§ 371 Date: Dec. 1, 2025

(30) Foreign Application Priority Data
May 31, 2023 (DE) 102023114220.8

(51) Int. Cl. H01Q 21/00; H01Q 1/32; H01Q 3/24

(52) U.S. Cl. CPC H01Q 21/0043; H01Q 1/3233; H01Q 3/24

(57) ABSTRACT

Disclosed is a radio-frequency transmitting and receiving assembly set having a slotted waveguide antenna assembly. The slotted waveguide antenna assembly includes multiple sets of slotted waveguide antennas. Each slotted waveguide antenna set includes an antenna feed element forming a set of multiple antenna feed elements. A circuit arrangement for transmitting and receiving radio frequency signals includes circuit connecting elements adapted to form radio frequency feed connections with the antenna feed elements. The slotted waveguide antenna assembly is mountable to the circuit arrangement at multiple different orientations. At each orientation a specific one of the antenna feed elements forms the radio frequency feed connection with a respective one of the circuit connecting elements.

### FIELD OF THE INVENTION

The invention relates to the field of slotted waveguide antenna assemblies and a method of mounting a radio frequency transmitting and receiving assembly set.

### BACKGROUND

Waveguide antennas or slotted waveguide antennas are the current state of the art for applications in radar sensors as well as in communication systems. The have desirable properties such as less standard deviation in their performance (i.e., gain and phase), compared to typical microstrip antennas, as well as flatter and easier integration into devices than typical horn antennas.

US20200220273A1 describes a waveguide antenna apparatus that includes a lower laminate layer of non-radio-frequency (RF) material and a first layer of conductive material formed on a top surface of the lower laminate layer of non-RF material. US20210382135A1 describes a vehicular radar sensing system that includes a radar sensor disposed at a vehicle.

It is an objective to provide for a system and method for mounting a radio frequency transmitting and receiving assembly set. The objectives underlying the invention are solved by the features of the independent claims.

### SUMMARY

The present invention relates to a radio-frequency transmitting and receiving assembly set, comprising a slotted waveguide antenna assembly, wherein the slotted waveguide antenna assembly comprises multiple sets of slotted waveguide antennas, wherein each slotted waveguide antenna set of the multiple sets of slotted waveguide antennas comprises an antenna feed element forming a set of multiple antenna feed elements and a circuit arrangement for transmitting and/or receiving radio frequency, RF, signals. The circuit arrangement further comprises one or more circuit connecting elements adapted to form RF feed connections with the antenna feed elements of the multiple antenna feed elements, wherein the slotted waveguide antenna assembly is mountable to the circuit arrangement at multiple different orientations, wherein at each orientation a specific antenna feed element of the set of multiple antenna feed elements forms the RF feed connection with a respective one of the circuit connecting elements.

In an example, the number of slotted waveguide antenna sets is equal to the number of different orientations, which e.g., means that for each specific slotted waveguide antenna set of the multiple slotted waveguide antenna sets, a different exclusive orientation to mount the assembly to the circuit arrangement may be available. The advantage of the presented features may be the combination of multiple different types of slotted waveguide antennas sets with different properties for different use cases on one slotted waveguide antenna assembly, where the active slotted waveguide antenna set may be chosen by changing the orientation of the mounting of the slotted waveguide antenna set to the circuit arrangement. This may decrease production costs, as it would only be necessary to manufacture one slotted waveguide antenna assembly that can serve different purposes depending on the use case.

In another example, there may be multiple antenna feed elements, where the number of antenna feed elements may correspond to the number of slotted waveguide antenna sets on the slotted waveguide antenna assembly, but there may be only one circuit connecting element. In that example, the multiple antenna feed elements may also correspond to the number of different orientations, and each one of these multiple antenna feed elements may be able to form the RF feed connection with the one circuit connecting element. This would provide an easy and cost-saving manufacturing of the circuit arrangement, which may later feed an RF signal to a specific slotted waveguide antenna set of the multiple slotted waveguide antenna sets through the same circuit connecting element. The active slotted waveguide antenna set may be chosen by changing the orientation of the mounting of the slotted waveguide antenna assembly to the circuit arrangement.

In an example, one antenna feed element when for example, forming an RF feed connection with one circuit connecting element, may be able to combine multiple RF connections, e.g., for sending and receiving RF signals to/from the respective slotted waveguide antenna set.

In a different example, there may be multiple antenna feed elements, where the number of antenna feed elements may correspond to the number of slotted waveguide antenna sets on the slotted waveguide antenna assembly, and also multiple circuit connecting elements. The number of circuit connecting elements may be equal or less then the number of antenna feed elements. In that example, one circuit connecting element may correspond and connect to one or more antenna feed elements. In this case, the active slotted waveguide antenna set may also be chosen by changing the orientation of the mounting of the slotted waveguide antenna assembly to the circuit arrangement.

For example, the assembly set may further comprise a printed circuit board, PCB, the PCB comprising the circuit arrangement, or a radio frequency integrated circuit, RFIC, comprising the circuit arrangement, or a system-on-a-chip, SOC, wherein the SOC comprises the circuit arrangement. The advantage of providing a PCB or an RFIC or an SOC, each of those comprising the circuit arrangement, may be to provide an easy platform for mounting and fastening the slotted waveguide antenna assembly, while simultaneously providing the RF feed platform comprising the circuit connecting elements to feed the slotted waveguide antenna assembly.

Preferably, either the PCB or the RFIC or the SOC may provide a specific mounting mechanism to realize the different exclusive orientations in which the slotted waveguide antenna assembly can be mounted to the circuit arrangement.

In the example of the assembly set comprising an RFIC, the RFIC may serve the purpose to enable the circuit arrangement to transmit and receive electromagnetic waves and/or radio frequencies. This may serve the purpose to enable a compact form factor of the combination of the slotted waveguide antenna assembly and the circuit arrangement, as the combined parts may not be relying on integrated circuits outside of the arrangement.

In the example of the assembly set comprising an SOC, the SOC also comprises e.g., via an integrated RFIC, a unit to transmit electromagnetic waves and/or radio frequencies and a unit to receive electromagnetic waves and/or radio frequencies, or a combined unit for transmitting and receiving electromagnetic waves and/or radio frequencies. In that example, the SOC may also be mounted directly to the assembly set without the PCB. The SOC may further comprise other interfaces, such as a digital signal processor, DSP, or an ethernet/network interface. Preferably, these additional units may enable the assembly set to including but not limited to process, store, analyze, pre-process, or post-process radio frequency, RF, data or any kind of data. By providing a compact SOC, a miniaturization of the device and a decrease in production cost by mass-producing and mounting the same circuit to a variety of slotted waveguide antenna assembly sets may be possible, as the produced hardware may be similar in the case of the SOC, but is enabled to mount, feed, and supply different sets of slotted waveguide antenna assembly sets.

In an example, the slotted waveguide antenna assembly is being adapted to indicate its mounted orientation to the circuit arrangement using contacts which are opened or closed upon the mounting specific to the different orientations, the circuit arrangement being adapted to control its operation in accordance with the indicated mounted orientation. Preferably, this may enable the circuit arrangement to determine the active slotted waveguide antenna set of the multiple slotted antenna sets by relying on the information provided by the contacts. In that case, the determination of the active slotted waveguide antenna element may not (only) be taken in the way the antenna feed elements connect to the circuit connecting elements, but in the way how one or more of the multiple contacts are open or closed. An example contact may be but is not limited to a mechanical, optical or an electrical connection between, for example, the slotted waveguide antenna assembly and the circuit arrangement.

In another example, in case of multiple ones of the circuit connecting elements, the circuit arrangement is adapted to perform the control of the operation by only activating the circuit connecting element currently forming the RF feed connection with the antenna feed element as indicated by the indicated mounted orientation. In an example, it may be unnecessary to feed RF signals through multiple RF connecting elements when only one may be in use. By deactivating the RF connecting elements which may not be necessary for the current operation, energy may be preserved.

In an example, the circuit arrangement is adapted to perform the control of the operation by adapting a generation of the RF signals and/or analysis of the received RF signals matched to the slotted waveguide antenna set currently being connected to the circuit connecting element and indicated by the indicated mounted orientation. In an example, the different slotted waveguide antenna sets of the slotted waveguide antenna assembly may have different characteristics, such as including but not limited to different wavelengths, different antenna gain, different antenna directivity or different antenna patterns. In an example, the operation of the circuit arrangement may be adapted to the characteristics of the currently active slotted waveguide antenna set to ensure that in case of transmitting signals, the signals that are fed to the antenna have the correct characteristics (such as e.g., frequency, modulation, and power), and in the case of receiving signals, the signals that are received from the antenna are correctly e.g., amplified, filtered and/or interpreted.

For example, the adapting of the generation of the RF signals matched to the slotted waveguide antenna set is comprising usage of at least one of an RF frequency, power, antenna element spacing and modulation specific to the slotted waveguide antenna set. The different slotted waveguide antenna sets of the slotted waveguide antenna assembly may be used for different purposes so that different properties for each antenna set may be desirable. As such, each slotted waveguide antenna set may be defined by specific properties, for example, by its RF transmission/reception wavelength, so that it may be advantageous to feed the antenna with an RF signal with a specific frequency range. The advantage of such a design may be that one slotted waveguide antenna assembly may be usable for different scenarios, where for each scenario at different RF frequency, power, and modulation is desirable. In one example, multiple configurations of the assembly may be mounted to different locations in a vehicle, where one slotted waveguide antenna set of the antenna assembly may be used for mid to long range radar functions such as including but not limited to front and corner radars for adaptive cruise control. A differently configured slotted waveguide antenna set of the antenna assembly may be used for near range applications such as including but not limited to blind spots detection, curbstone detection in parking assistance, or obstacle, pedestrian and cyclist detection for door opening warnings. In those examples, different frequencies, power, and modulation characteristics of the RF signal may be advantageous, and for each one of the specifically characterized signals, the use of a specific slotted waveguide antenna may be necessary. The RF receive chain could be adapted accordingly. In another example, different or identical waveforms may be used for the different slotted waveguide antenna sets and the spacing between the antenna elements as compared between the different slotted waveguide antenna sets may be different. This would allow for different sensor performance characteristics.

In an example, each slotted waveguide antenna set comprises between 1 and 8 slotted waveguide antennas for receiving radio frequency signals and between 1 and 8 slotted waveguide antennas for transmitting radio frequency signals, preferably between 3 and 5 slotted waveguide antennas for receiving radio frequency signals and between 3 and 5 slotted waveguide antennas for transmitting radio frequency signals, most preferably between 3 and 4 slotted waveguide antennas for receiving radio frequency signals and between 3 and 4 slotted waveguide antennas for transmitting radio frequency signals. In an example, a slotted waveguide antenna set may comprise four transmitter (Tx) and four receiver (Rx) elements. In another example of a minimal configuration, there may be one TRx, transmitting and receiving channel with a single transceiver antenna, where the antenna element may be performing the function of both the transmitter and receiver antenna.

Preferably, the slotted waveguide antenna set further comprises fixation means for fixing the waveguide antenna assembly to the circuit arrangement, the fixation means being adapted to exclusively permit the fixation in the multiple different orientations. The fixation means may comprise opposing connections or opposing joints such as including but not limited to clamp connections, welding connections, riveting connections, soldering connections, and/or screw connections. At least one fixation point may be on the slotted waveguide antenna assembly, the opposing at least one fixation point may either be on the PCB and/or on the RFIC and/or on the SOC, each of these comprising the circuit arrangement.

In an example, the slots of the multiple sets of slotted waveguide antennas are comprised in a common radiating surface. An advantage of this solution may be a compact form factor, as only a single radiating surface may be needed. The antenna assembly may be flatter and easier to integrate into devices.

Preferably, the radiating surface is a one-piece surface. This may further decrease production costs and increase production speed, as in order to manufacture one slotted waveguide antenna assembly, only one piece of material needs to be machined, which may then comprise multiple slotted waveguide antenna sets. In an example, the material may be metal, metalized plastic or any kind of conductive material. In another example, instead of milling the slots, the slotted waveguide antenna assembly may be produced in multiple layers to form the slots and holes. In another example, the common radiating surface may be 3D printed. Preferably, there may typically be one layer of feed network that may connect to the circuit arrangement, the RFIC, or the SOC, via the RF connection between the antenna feed element and the circuit connecting element, one layer of resonant cavity/coupling aperture, which may be the sandwiched transition layer, and one radiating layer on which the slots may be located.

In another aspect, a method of mounting a radio-frequency transmitting and receiving assembly set is described, the method comprising providing a slotted waveguide antenna assembly, wherein the slotted waveguide antenna assembly comprises multiple sets of slotted waveguide antennas, wherein each waveguide antenna set of the multiple sets of slotted waveguide antennas comprises an antenna feed element forming a set of multiple antenna feed elements; and providing a circuit arrangement for transmitting and receiving radio frequency, RF, signals, wherein the circuit arrangement further comprises one or more circuit connecting elements adapted to form RF feed connections with the antenna feed elements of the multiple antenna feed elements, mounting the slotted waveguide antenna assembly to the circuit arrangement at one of multiple different orientations, wherein at each orientation a specific one of the antenna feed elements forms the RF feed connection with a respective one of the circuit connecting elements.

It is understood that one or more of the aforementioned examples may be combined as long as the combined examples are not mutually exclusive.

### BRIEF DESCRIPTION OF THE DRAWINGS

In the following, examples are described in greater detail making reference to the drawings in which:

FIG. 1 is a schematic of a side view of a radio-frequency transmitting and receiving assembly set.

FIG. 2 is a schematic of the frontside of a slotted waveguide antenna assembly.

FIG. 3 is a schematic of the backside of a slotted waveguide antenna assembly.

FIG. 4 is a schematic of a side view of radio-frequency transmitting and receiving assembly set.

FIG. 5 is a schematic of a side view of radio-frequency transmitting and receiving assembly set.

FIG. 6 is a schematic of a side view of radio-frequency transmitting and receiving assembly set.

### DETAILED DESCRIPTION

In the following, similar elements are denoted by the same reference numerals.

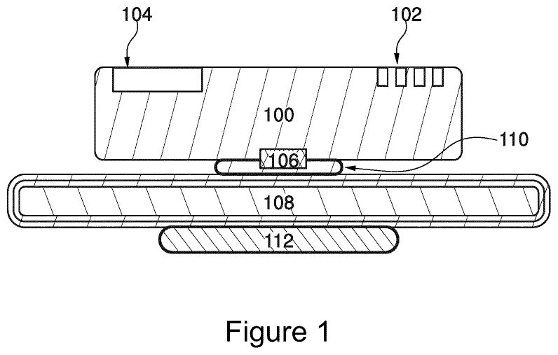

FIG. 1 shows a schematic of a side view of a radio-frequency transmitting and receiving assembly set, comprising a slotted waveguide antenna assembly 100 with slotted waveguide antenna sets with respective sets of waveguide antennas. Each set comprises e.g., multiple antennas each being formed by one or more respective slots, 102 and 104. The slotted waveguide antenna assembly 100 comprises multiple antenna feed elements 106 and is mounted to a PCB 108. One of the antenna feed elements 106 is coupled to a circuit connecting element 110 which is part of the PCB 108. The PCB 108 further comprises a circuit arrangement 112 on the opposing side of the PCB 108, opposite to the slotted waveguide antenna assembly.

In the present example, it is assumed that the slotted waveguide antenna assembly comprises two slotted waveguide antenna sets with respective slots 102 and 104. Here, the slotted waveguide antenna assembly 100 can be mounted in two exclusive orientations on the PCB 108. For example, the exclusive orientation may be chosen by rotating the slotted waveguide antenna assembly 100 by 90° in the horizontal plane of the FIG. 1. In this example, the horizontal plane is defined as follows: the circuit arrangement 112 is mounted on the underside of the PCB 108, and the slotted waveguide antenna assembly 100 is mounted on the top side of the PCB 108. With the PCB 108 defining a plane, rotating the slotted waveguide antenna assembly 100 by 90° in the horizontal plane means that the rotational axis would be the axis perpendicular to the plane defined by the PCB.

Depending on which exclusive orientation is chosen by mounting the slotted waveguide antenna assembly 100 to the PCB 108, e.g., one antenna feed element out of the two antenna feed elements 106 can be connected with the circuit arrangement 112 by forming an RF feed connection with the circuit connecting element 110. Each antenna feed element and the circuit connecting element can have multiple RF channels to communicate RF signals between the waveguide antennas and the circuit arrangement 112. In the example depicted in FIG. 1, the antenna feed element 106 is coupled to the waveguide antenna set comprising the slots 102. For example, by mounting the slotted waveguide antenna assembly 100 in a different one of the exclusive orientations to the PCB, the other one of the two antenna feed elements with the slots 104 would form an RF feed connection with the circuit connecting element 110. So, a single assembly set may be used with multiple sets of waveguide antennas, wherein depending on the orientation of mounting of the waveguide antenna assembly 100 on the PCB 108, a specific set of the waveguide antennas with slots 102 or 104 can be used.

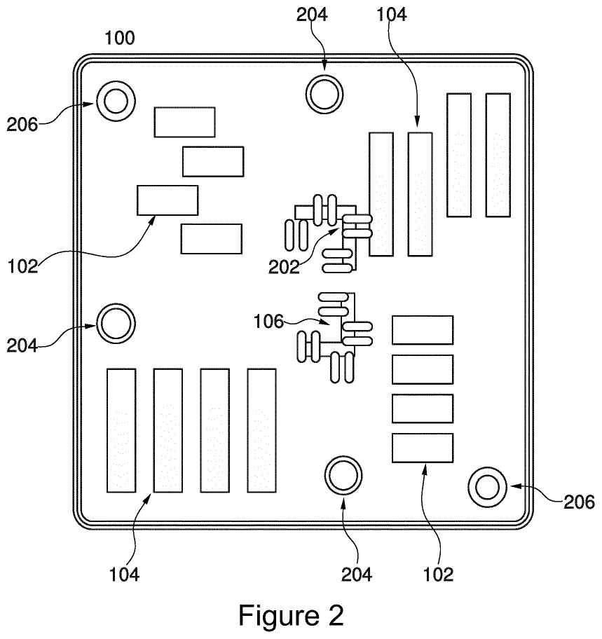

FIG. 2 shows a schematic of a slotted waveguide antenna assembly, 100. In the example, the slotted waveguide antenna assembly 100 comprises two sets of slotted waveguide antennas, each set comprising e.g., multiple antennas, each antenna e.g., being formed by one or more respective slots. Slots 102 and 104 each correspond to a different one of the two sets of waveguide antennas. Furthermore, FIG. 2 shows eight slots per slotted waveguide antenna set, in which 4 of the 8 slots serve as receiving (RX) antenna channels and the other 4 of the 8 slots serve as transmitting (TX) antenna channels. Each of the 4 receiving and 4 transmitting channels per slotted waveguide antenna set in the example are paired, forming an array of 4 slots per receiving/transmitting pair. The slots of each channel may have different widths and lengths, which determines the different properties of each antenna set (i.e., specific RF frequency, power, and modulation for each slotted waveguide antenna).

The slotted waveguide antenna assembly 100 in FIG. 2 further comprises two antenna feed elements, 106 and 202, which are e.g., on the backside of the slotted waveguide antenna assembly. Hence, the antenna feed elements are not on the front side of the slotted waveguide antenna assembly which is presented in FIG. 2 and are only shown for illustrative purposes. In the example of FIG. 2, it is assumed that the antenna feed element 106 is the one currently being used, thus being the active antenna feed element, which therefore forms an RF feed connection with the circuit connecting element that is not visible in the figure. In this example, the other antenna feed element, 202, is currently not forming an RF feed connection with the circuit connecting element, and inactive. The antenna feed element 106 e.g., feeds and receives RF signals to and from the slotted waveguide antenna set with the waveguide antenna slots 102. The antenna feed element 202 would feed and receive RF signals to and from the slotted waveguide antenna set with the waveguide antenna slots 104 if it was active. In the present example, the waveguide antenna slots 102 of the respective slotted waveguide antenna set and its 4 transmitting and 4 receiving channels are currently active.

The slotted waveguide antenna assembly 100 of FIG. 2 further comprises two sets of holes, 204 and 206, for fixation means with e.g., screws. In this example, one set of holes, 204, corresponds to one exclusive orientation out of the two possible exclusive orientations, and the other set of holes, 206, corresponds to the other possible exclusive orientation, which can be chosen by rotating the slotted waveguide antenna assembly 100 by 90° in the plane of FIG. 2.

In the present example of FIG. 2, with the waveguide antenna slots 102 being the slots of the active slotted waveguide antenna set and 106 being the antenna feed element currently in use, the holes 204 are used to fixate the slotted waveguide antenna assembly to the PCB, the RFIC or the SOC, and permit the mounting in one out of the two possible exclusive orientations of the slotted waveguide antenna assembly. The slotted waveguide antenna assembly may be mounted (and fixed via the holes 206) rotated by 90° in the right direction, so that the antenna feed element 202 would then establish an RF connection with the circuit connecting element. In that case, the holes 206 would align with the counterpart holes on the PCB, the RFIC or the SOC, allowing the fixation of the slotted waveguide antenna assembly in the other exclusive one of the two possible orientations. As a result, the waveguide antenna slots 104 of the other one of the two slotted waveguide antenna sets would become active to transmit and receive radio frequencies.

In the slotted waveguide antenna assembly 100 of FIG. 2, the waveguide antenna slots 104 are larger and longer, while the waveguide antenna slots 102 are overall shorter and more compact. The larger the antenna element with the larger waveguide antenna slots 104 are more directive its radiation pattern, and hence more power can be radiated in a desired direction. The slotted waveguide antenna set with the waveguide antenna slots 104 may thus be used in vehicles for mid-to long-range radar functions e.g., for front and corner radars that may be employed for adaptive cruise control (ACC) or parking assistance purposes. The slotted waveguide antenna set with the waveguide antenna slots 102 may be used for near range applications e.g., blind spot detection; curbstone detection in parking assistance; obstacle, or pedestrian and cyclist detection for door opening warning.

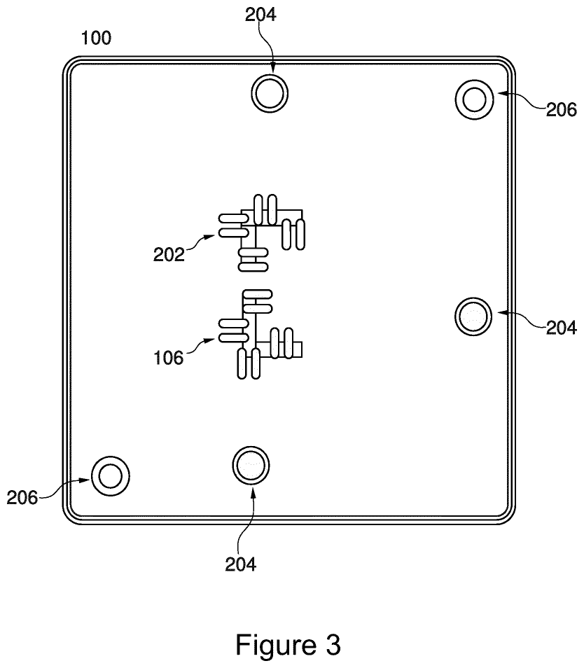

FIG. 3 shows a schematic of the backside of the slotted waveguide antenna assembly 100, e.g., the one discussed above in FIG. 2. In this example, the antenna feed elements 106 and 202 are on the back side of the arrangement shown in the figure. Also, the backside e.g., comprises the holes 204 and 206, which allow for the mounting of the slotted waveguide antenna assembly on the circuit arrangement in one out of the two possible exclusive orientations.

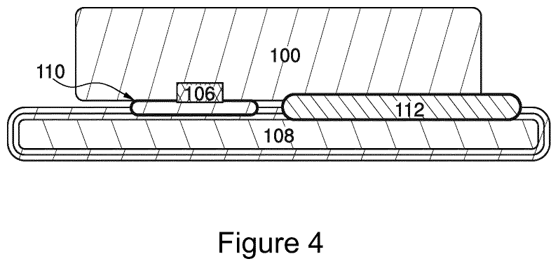

FIG. 4 shows another schematic of a side view of the slotted waveguide antenna assembly 100 mounted to a PCB 108. In this example, the characteristics of this schematics are similar to FIG. 1, but in the present example, the circuit arrangement 112 is on the same side of the PCB 108 as the slotted waveguide antenna assembly 100, adjacent to the RF feed connection formed by the antenna feed element 106 and the circuit connecting element 110.

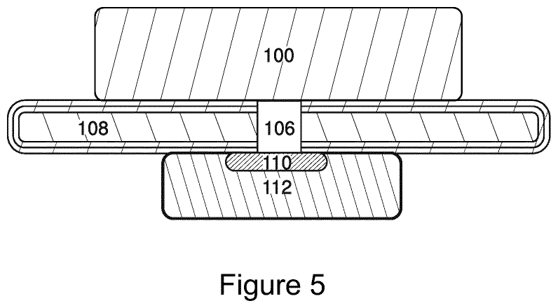

FIG. 5 shows another schematic of a side view of the slotted waveguide antenna assembly 100 mounted to a PCB 108. In this example, the circuit arrangement 112 is on the opposite side of the PCB 108 as compared to FIG. 1. However, in this example, the circuit connecting element 110 is now directly comprised by the circuit arrangement 112, and the antenna feed element 106 traverses through the PCB 108 to form the RF feed connection.

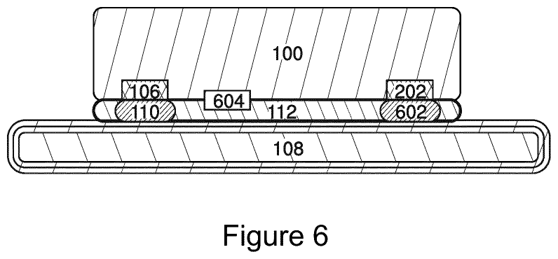

FIG. 6 shows another schematic of a side view of the slotted waveguide antenna assembly 100 mounted to a PCB 108. In this example, the slotted waveguide antenna assembly 100 is directly mounted to the circuit arrangement 112, and the circuit arrangement 112 is further attached to the PCB 108. In addition, the circuit arrangement 112 comprises two circuit connecting elements 106 and 202, and the slotted waveguide antenna assembly 100 comprises two antenna feed elements 106 and 202. FIG. 6 further comprises a contact 604, which current status (e.g., opened or closed) indicates that e.g., in the case of an opened contact 604, the slotted waveguide antenna assembly 100 is mounted in a first exclusive orientation out of two possible exclusive orientations and in the case of a closed contact 604, the slotted waveguide antenna assembly 100 is mounted in the second exclusive orientation out of two possible exclusive orientations.

In the first exclusive orientation, the antenna feed element 106 is coupled to the circuit connecting element 110, while in the second exclusive orientation the antenna feed element 202 is coupled to the circuit connecting element 602.

For example in FIG. 6, the contact is opened, indicating that the slotted waveguide antenna assembly 100 is mounted in the first exclusive orientation, which then determines that the antenna feed element 106 and the respective circuit connecting element 110 are the active elements to form the RF feed connection. In this example, there currently is no active RF feed connection between the antenna feed element 202 and the circuit connecting element 602. For example, if the slotted waveguide antenna assembly 100 would be mounted in the second exclusive orientation, the contact 604 would be closed, so there would be an RF feed connection between the antenna feed element 202 and the circuit connecting element 602. In this example, when the contact 604 is closed, there would be no RF feed connection between the antenna feed element 106 and the circuit connecting element 110.

It has to be noted that the contact 604 may also be used in conjunction with the examples of FIGS. 1-5, in which only a single circuit connecting element 602 was used. In this case, the state of the contact 604 may indicate the currently used orientation of the assembly 100, i.e., which antenna feed element and therefore which set of waveguide antennas is currently being in use and coupled to the circuit arrangement 112.

While the invention has been illustrated and described in detail in the drawings and foregoing description, such illustration and description are to be considered illustrative or exemplary and not restrictive; the invention is not limited to the disclosed examples.

### REFERENCE SIGNS LIST

100 slotted waveguide antenna assembly
102 waveguide antenna slots
104 waveguide antenna slots
106 antenna feed element
108 printed circuit board, PCB
110 circuit connecting element
112 circuit arrangement
202 antenna feed element
204 holes
206 holes
602 circuit connecting element
604 contact

1. A radio-frequency transmitting and receiving assembly set, comprising:
a slotted waveguide antenna assembly comprising multiple sets of slotted waveguide antennas,
wherein each slotted waveguide antenna set of the multiple sets of slotted waveguide antennas comprises an antenna feed element forming a set of multiple antenna feed elements; and
a circuit arrangement for transmitting and/or receiving radio frequency signals, comprising
one or more circuit connecting elements adapted to form radio frequency feed connections with antenna feed elements of the multiple antenna feed elements,
wherein the slotted waveguide antenna assembly is mountable to the circuit arrangement at multiple different orientations,
wherein at each orientation a specific one of the antenna feed elements forms a radio frequency feed connection with a respective one of the circuit connecting elements.

2. The radio-frequency transmitting and receiving assembly set of claim 1, further comprising:
a printed circuit board comprising the circuit arrangement; or
a radio frequency integrated circuit comprising the circuit arrangement; or
a system-on-a-chip comprising the circuit arrangement.

3. The radio-frequency transmitting and receiving assembly set of claim 1, wherein the slotted waveguide antenna assembly is adapted to indicate a mounted orientation to the circuit arrangement using contacts which are opened or closed upon a mounting specific to the multiple different orientations, wherein the circuit arrangement is adapted to control an operation in accordance with the mounted orientation.

4. The radio-frequency transmitting and receiving assembly of claim 3, wherein in a case of multiple circuit connecting elements, the circuit arrangement is adapted to control the operation by only activating the circuit connecting element currently forming the radio frequency feed connection with the antenna feed element as indicated by the mounted orientation.

5. The radio-frequency transmitting and receiving assembly of claim 3, wherein the circuit arrangement is adapted to control the operation by adapting a generation of the radio frequency signals and/or an analysis of the received radio frequency signals matched to a slotted waveguide antenna set currently connected to a circuit connecting element and indicated by the mounted orientation.

6. The radio-frequency transmitting and receiving assembly of claim 5, wherein adapting the generation of the radio frequency signals matched to the slotted waveguide antenna set comprises usage of at least one of a radio frequency, a power, an antenna element spacing, and a modulation specific to the slotted waveguide antenna set.

7. The radio-frequency transmitting and receiving assembly set of claim 1, wherein each slotted waveguide antenna set comprises between 1 and 8 slotted waveguide antennas for receiving radio frequency signals and between 1 and 8 slotted waveguide antennas for transmitting radio frequency signals.

8. The radio-frequency transmitting and receiving assembly set of claim 1, further comprising fixation means for fixing the slotted waveguide antenna assembly to the circuit arrangement, wherein the fixation means is adapted to exclusively permit fixation in the multiple different orientations.

9. The radio-frequency transmitting and receiving assembly set of claim 1, wherein slots of the multiple sets of slotted waveguide antennas are comprised in a radiating surface.

10. The radio-frequency transmitting and receiving assembly set of claim 9, wherein the radiating surface is a one-piece surface.

11. A method of mounting a radio-frequency transmitting and receiving assembly set, the method comprising:
providing a slotted waveguide antenna assembly, wherein the slotted waveguide antenna assembly comprises multiple sets of slotted waveguide antennas, wherein each slotted waveguide antenna set of the multiple sets of slotted waveguide antennas comprises an antenna feed element forming a set of multiple antenna feed elements;
providing a circuit arrangement for transmitting and receiving radio frequency signals, wherein the circuit arrangement comprises one or more circuit connecting elements adapted to form radio frequency feed connections with antenna feed elements of the multiple antenna feed elements; and
mounting the slotted waveguide antenna assembly to the circuit arrangement at one of multiple different orientations, wherein at each orientation a specific one of the antenna feed elements forms a radio frequency feed connection with a respective one of the circuit connecting elements.
